(19) United States
(12) Patent Application Publication
(10) Pub. No.: US 2014/0357533 A1
(43) Pub. Date: Dec. 4, 2014

(54) DRILLING FLUIDS COMPRISING FARNESANE AND/OR FARNESENE

(71) Applicant: AMYRIS, INC., Emeryville, CA (US)

(72) Inventors: Jason Wells, San Francisco, CA (US); Joseph G. Doolan, Emeryville, CA (US)

(73) Assignee: AMYRIS, INC., Emeryville, CA (US)

(21) Appl. No.: 14/358,228

(22) PCT Filed: Dec. 6, 2012
(86) PCT No.: PCT/US12/68054

§ 371 Date: May 15, 2014

Related U.S. Application Data
(60) Provisional application No. 61/578,248, filed on Dec. 21, 2011.
(60) Provisional application No. 61/606,987, filed on Mar. 5, 2012.

(51) Int. Cl. C09K 8/20

(52) U.S. Cl. CPC C09K 8/20
USPC 507/126; 507/103

(57) ABSTRACT

Provided herein are drilling fluids comprising microbial-derived bio-organic compounds, a weighting agent and a viscosifier. In some embodiments, the microbial-derived bio-organic compounds comprise a famesane, a farnesene or a combination thereof. In certain embodiments, the drilling fluid comprises a continuous phase comprising a famesane, a farnesene or a combination thereof; and a discontinuous phase comprising water or an aqueous solution, an emulsifier, a weighting agent and a viscosifier. In other embodiments, the viscosifier is an organophillic clay.

### PRIOR RELATED APPLICATIONS

This is a U.S. national stage application of the International Patent Application No. PCT/US2012/068054, filed Dec. 6, 2012, which claims priority to U.S. Provisional Patent Application No. 61/578,248, filed Dec. 21, 2011 and U.S. Provisional Patent Application No. 61/606,987, filed Mar. 5, 2012, all of which are incorporated herein by reference in their entireties.

### FIELD OF THE INVENTION

Provided herein are drilling fluids comprising microbial-derived bio-organic compounds, a weighting agent and a viscosifier. In some embodiments, the bio-organic compounds comprise a farnesane, a farnesene or a combination thereof.

### BACKGROUND OF THE INVENTION

Biological engineering can provide renewable and environmental friendly sources for making drilling fluid compositions. For example, isoprenoids comprise a diverse class of compounds with over 50,000 members and have a variety of uses including as specialty chemicals, pharmaceuticals and fuels. Conventionally, isoprenoids can be synthesized from petroleum sources or extracted from plant sources. More recently, methods of making such compounds from microbial cells has been developed. For instance, isoprenoids and other microbial-derived compounds and compositions as well as methods of making them have been described in, for example, U.S. Pat. Nos. 7,399,323, 7,540,888, 7,671,245, 7,592,295, 7,589,243, 7,655,739, 7,806,944, 7,854,774, 7,846,222, 7,942,940, and 7,935,156, all of which are incorporate herein by reference.

Drilling fluid is a fluid used to facilitate the drilling of boreholes into the earth generally for the exploitation of natural resources such as oil, natural gas and water. Liquid drilling fluid is also known as drilling mud. There are generally three main types of drilling fluids: water-based drilling fluids, non-aqueous drilling fluids (aka oil-based drilling fluids), and gaseous drilling fluids using a wide range of gases. Drilling fluids generally comprise a viscosifier such as bentonite with one or more additives such as a weighting agent, a surfactant, a detergent builder, a fluid loss reducer, a lubricant, a defoamer, a pH control material, a deflocculant and the like. All these chemicals generally have negative impacts on the land and sea around the drilling operations. Given the impacts of the current drilling fluids on the environment, there is an increasing demand for more renewable and environmental friendly alternatives.

Therefore, there is a need for renewable and environmental friendly drilling fluids. There is also a need for improved drilling fluids to satisfy various demanding applications in the drilling industry.

### SUMMARY OF THE INVENTION

Provided herein are drilling fluids comprising a farnesane, a farnesene or a combination thereof.

In one aspect, provided herein is a drilling fluid comprising a farnesane, a weighting agent and a viscosifier, wherein the drilling fluid is free of a cyclic terpene and dimethyloctane. In some embodiments, the farnesane in the drilling fluid disclosed herein is in an amount from about 1 vol. % to about 95 vol. %, based on the total volume of the drilling fluid. In certain embodiments, the drilling fluid further comprises a farnesene. In some embodiments, the total amount of the farnesane and the farnesene is from about 1 vol. % to about 95 vol. %, based on the total volume of the drilling fluid. In certain embodiments, the mole ratio of the farnesane to the farnesene is from about 10:1 to about 1:10.

In another aspect, provided herein is a drilling fluid comprising a farnesene, a weighting agent and a viscosifier, wherein the drilling fluid is free of a cyclic terpene and dimethyloctane. In certain embodiments, the farnesene is in an amount from about 1 vol. % to about 95 vol. %, based on the total volume of the drilling fluid.

In some embodiments, the weighting agent of the drilling fluid disclosed herein is barite. In some embodiments, the viscosifier of the drilling fluid disclosed herein is an organophillic clay. In some embodiments, the drilling fluid disclosed herein further comprising an asphalt.

In another aspect, provided herein is a drilling fluid comprising:

(a) a continuous phase comprising a farnesane in an amount from about 1 vol. % to about 100 vol. %, based on the total volume of the continuous phase, wherein the continuous phase is free of a cyclic terpene and dimethyloctane; and

(b) a discontinuous phase comprising water or an aqueous solution, an emulsifier, a weighting agent and a viscosifier.

In some embodiments, the amount of the farnesane is from about 1 vol. % to about 50 vol. %, or from about 50 vol. % to about 100 vol. %, based on the total volume of the continuous phase. In certain embodiments, the drilling fluid further comprises a farnesene. In some embodiments, the total amount of the farnesane and the farnesene is from about 1 vol. % to about 100 vol. %, based on the total volume of the continuous phase. In certain embodiments, the total amount of the farnesane and the farnesene is from about 1 vol. % to about 50 vol. %, or from about 50 vol. % to about 100 vol. %, based on the total volume of the continuous phase. In some embodiments, the mole ratio of the farnesane to the farnesene is from about 10:1 to about 1:10.

In another aspect, provided herein is a drilling fluid comprising:

(a) a continuous phase comprising a farnesene in an amount from about 1 vol. % to about 100 vol. %, based on the total volume of the continuous phase, wherein the continuous phase is free of a cyclic terpene and dimethyloctane; and

(b) a discontinuous phase comprising water or an aqueous solution, an emulsifier, a weighting agent and a viscosifier.

In certain embodiments, the amount of the farnesene is from about 50 vol. % to about 100 vol. %, from about 1 vol. % to about 50 vol. %, based on the total volume of the continuous phase. In some embodiments, the continuous phase further comprises a diesel oil, a mineral oil, a vegetable oil, a biodiesel oil, a liquid ester, a liquid poly-α-olefin, a liquid mono-ether, a liquid di-ether, a linear alkylbenzene or a combination thereof. In certain embodiments, the continuous phase is substantially free of a diesel oil, a mineral oil, a vegetable oil, a biodiesel oil, a liquid ester, a liquid poly-α-olefin, a liquid mono-ether, a liquid di-ether, a linear alkylbenzene or a combination thereof.

In another aspect, provided herein is a drilling fluid comprising farnesane and an organophilic clay. In some embodiments, the drilling fluid further comprises an asphalt. In certain embodiments, the drilling fluid further comprises a weighting agent. In some embodiments, the drilling fluid further comprises an emulsifier and water or an aqueous solution.

In another aspect, provided herein is a drilling fluid comprising farnesene and an organophilic clay. In some embodiments, the drilling fluid further comprises an asphalt. In certain embodiments, the drilling fluid further comprises a weighting agent. In some embodiments, the drilling fluid further comprises an emulsifier and water or an aqueous solution.

In some embodiments, the aqueous solution is sea water, a brine, or a combination thereof. In certain embodiments, the brine comprises sodium chloride, calcium chloride, or a combination thereof.

### DETAILED DESCRIPTION OF THE INVENTION

### Terminology

“Bio-organic compound” or “microbially-derived bio-organic compound” refers to a compound that is made by microbial cells (both recombinant as well as naturally occurring). In certain embodiments, the microbially-derived bio-organic compound is an isoprenoid. In some embodiments, the microbially-derived bio-organic compound is a C₅-C₂₀ isoprenoid. In other embodiments, the microbially-derived bio-organic compound is a C₁₅ isoprenoid. In further embodiments, the microbially-derived bio-organic compound is a farnesane or a farnesene such as α-farnesene and β-farnesene.

A drilling fluid that is “substantially free” of a compound means that the drilling fluid contains less than about 20 vol. %, less than about 10 vol. %, less than about 5 vol. %, less than about 3 vol. %, less than about 1 vol. %, less than about 0.5 vol. %, less than about 0.1 vol. %, or less than about 0.01 vol. % of the compound, based on the total volume of the drilling fluid.

In the following description, all numbers disclosed herein are approximate values, regardless whether the word “about” or “approximate” is used in connection therewith. Numbers may vary by 1 percent, 2 percent, 5 percent or, sometimes, 10 to 20 percent. Whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent or 100 percent. Moreover, any numerical range defined by two R numbers as defined in the above is also specifically disclosed.

In one aspect of the present invention, a microbial-derived bio-organic compound replaces an existing oil in either conventional water-based drilling fluids or oil-based drilling fluids. In some embodiments, the drilling fluid is a water-based drilling fluid comprising a microbially-derived bio-organic compound, wherein the drilling fluid is substantially free of one or more of a diesel oil, a mineral oil, benzene, dimethyloctane, and a cyclic terpene. In other embodiments, the drilling fluid comprises a microbially-derived bio-organic compound wherein the drilling fluid is substantially free of benzene and/or a cyclic terpene. In other embodiments, the drilling fluid disclosed herein further comprises a surfactant, a weighting agent, and a viscosifier. In certain embodiments, the microbially derived bio-organic compound is a farnesene such as α-farnesene, β-farnesene, or a combination thereof. In some embodiments, the microbially-derived bio-organic compound is farnesane. In certain embodiments, the microbially derived bio-organic compound is a farnesene, farnesane or a combination thereof.

In some embodiments, the drilling fluid comprises a farnesene, a farnesane, or a combination thereof wherein the drilling fluid is substantially free of one or more of a diesel oil, a mineral oil, a vegetable oil, a biodiesel oil, a liquid ester, a liquid poly-α-olefin, a liquid mono-ether, a liquid di-ether, a cyclic terpene, dimethyloctane, benzene, and a linear alkylbenzene. Because of the outstanding cold properties of a farnesene or a farnesane (e.g., low freezing point and pour point), unlike some of the synthetic oil based drilling fluids, the farnesene/farnesane-containing drilling fluids disclosed herein may not require the addition of a pour point depressant for lowering the pour point of the drilling fluid or a freezing point depressant for lowering the freezing point of the drilling fluid. In some embodiments, the drilling fluid disclosed herein is substantially free of a pour point depressant, a freezing point depressant or a combination thereof.

In some embodiments, the drilling fluid is an oil-based drilling fluid comprising a microbially-derived bio-organic compound, wherein the drilling fluid is substantially free of one or more of a diesel oil, a mineral oil, benzene, dimethyloctane, and a cyclic terpene. In other embodiments, the drilling fluid comprises a microbially-derived bio-organic compound wherein the drilling fluid is substantially free of benzene and/or a cyclic terpene. In other embodiments, the oil-based drilling fluid comprises water or an aqueous solution, wherein the water content of the oil-based drilling fluid is less than about 0.1 vol. %, less than about 0.5 vol. %, less than about 1 vol. %, less than about 2 vol. %, less than about 3 vol. %, less than about 4 vol. %, less than about 5 vol. %, less than about 10 vol. %, or less than about 15 vol. %, based on the total volume of the oil-based drilling fluid. In other embodiments, the oil-based drilling fluid has is an invert emulsion and has a water content of at most about 20 vol. %, at most about 25 vol. %, at most about 30 vol. %, at most about 35 vol. %, at most about 40 vol. %, at most about 45 vol. %, at most about 50 vol. %, at most about 60 vol. %, at most about 70 vol. %, at most about 80 vol. %, or at most about 90 vol. %, based on the total volume of the oil-based drilling fluid. In other embodiments, the oil-based drilling fluid disclosed herein further comprises an emulsifier, a weighting agent, a viscosifier, or a combination thereof. In certain embodiments, the microbially derived bio-organic compound is a farnesene such as α-farnesene, β-farnesene, or a combination thereof. In some embodiments, the microbially-derived bio-organic compound is a farnesane. In certain embodiments, the microbially derived bio-organic compound is a farnesene, a farnesane or a combination thereof.

In some embodiments, the oil-based drilling fluid comprises: (a) a continuous phase comprising a farnesane; and (b) a discontinuous phase comprising water or an aqueous solution, an emulsifier, a weighting agent and a viscosifier. In certain embodiments, the drilling fluid comprises: (a) a continuous phase comprising a farnesene; and (b) a discontinuous phase comprising water or an aqueous solution, an emulsifier, a weighting agent and a viscosifier. In some embodiments, the drilling fluid comprises: (a) a continuous phase comprising a farnesane and a farnesene; and (b) a discontinuous phase comprising water or an aqueous solution, an emulsifier, a weighting agent and a viscosifier. In certain embodiments, the continuous phase further comprises a diesel oil, a mineral oil, a vegetable oil, a biodiesel oil, a liquid ester, a liquid poly-α-olefin, a liquid mono-ether, a liquid di-ether, a linear alkylbenzene or a combination thereof. In some embodiments, the continuous phase is substantially free of one or more of a diesel oil, a mineral oil, a vegetable oil, a biodiesel oil, a liquid ester, a liquid poly-α-olefin, a liquid mono-ether, a liquid di-ether, a cyclic terpene, dimethyloctane, benzene, and a linear alkylbenzene.

In some embodiments, the aqueous solution in the oil-based drilling fluids disclosed herein is sea water. In other embodiments, the aqueous solution is a brine. In some embodiments, the brine comprises sodium chloride, calcium chloride, or a combination thereof.

The amount of water or the aqueous solution in the discontinuous phase is from about 5 vol. % to about 50 vol. %, from about 5 vol. % to about 40 vol. %, from about 5 vol. % to about 30 vol. %, from about 5 vol. % to about 25 vol. %, or from about 10 vol. % to about 25 vol. %, based on the total volume of the discontinuous phase.

The amount of the discontinuous phase in the drilling fluid is from about 1 vol. % to about 50 vol. %, from about 1 vol. % to about 40 vol. %, from about 1 vol. % to about 30 vol. %, or from about 1 vol. % to about 25 vol. %, based on the total volume of the drilling fluid.

The amount of the continuous phase in the drilling fluid is from about 50 vol. % to about 99 vol. %, from about 60 vol. % to about 99 vol. %, from about 70 vol. % to about 99 vol. %, or from about 50 vol. % to about 80 vol. %, based on the total volume of the drilling fluid.

In certain embodiments, the farnesane in the drilling fluid or continuous phase disclosed herein is in an amount from about 1 vol. % to about 100 vol. %, from about 1 vol. % to about 99 vol. %, from about 1 vol. % to about 95 vol. %, from about 1 vol. % to about 90 vol. %, from about 1 vol. % to about 80 vol. %, from about 1 vol. % to about 70 vol. %, from about 1 vol. % to about 60 vol. %, from about 1 vol. % to about 50 vol. %, from about 1 vol. % to about 40 vol. %, from about 1 vol. % to about 30 vol. %, from about 1 vol. % to about 20 vol. %, from about 1 vol. % to about 10 vol. %, from about 10 vol. % to about 99 vol. %, from about 20 vol. % to about 99 vol. %, from about 30 vol. % to about 99 vol. %, from about 40 vol. % to about 99 vol. %, from about 50 vol. % to about 100 vol. %, from about 60 vol. % to about 100 vol. %, from about 70 vol. % to about 100 vol. %, from about 80 vol. % to about 100 vol. %, or from about 90 vol. % to about 100 vol. %, based on the total volume of the drilling fluid. In some embodiments, the amount of the farnesane in the drilling fluid is less than 30 vol. %, based on the total volume of the drilling fluid.

In some embodiments, the farnesene in the drilling fluid or continuous phase disclosed herein is in an amount from about 1 vol. % to about 100 vol. %, from about 1 vol. % to about 99 vol. %, from about 1 vol. % to about 95 vol. %, from about 1 vol. % to about 90 vol. %, from about 1 vol. % to about 80 vol. %, from about 1 vol. % to about 70 vol. %, from about 1 vol. % to about 60 vol. %, from about 1 vol. % to about 50 vol. %, from about 1 vol. % to about 40 vol. %, from about 1 vol. % to about 30 vol. %, from about 1 vol. % to about 20 vol. %, from about 1 vol. % to about 10 vol. %, from about 10 vol. % to about 99 vol. %, from about 20 vol. % to about 99 vol. %, from about 30 vol. % to about 99 vol. %, from about 40 vol. % to about 99 vol. %, from about 50 vol. % to about 100 vol. %, from about 60 vol. % to about 100 vol. %, from about 70 vol. % to about 100 vol. %, from about 80 vol. % to about 100 vol. %, or from about 90 vol. % to about 100 vol. %, based on the total volume of the drilling fluid.

In certain embodiments, the total amount of the farnesane and the farnesene in the drilling fluid or continuous phase disclosed herein is from about 1 vol. % to about 100 vol. %, from about 1 vol. % to about 99 vol. %, from about 1 vol. % to about 95 vol. %, from about 1 vol. % to about 90 vol. %, from about 1 vol. % to about 80 vol. %, from about 1 vol. % to about 70 vol. %, from about 1 vol. % to about 60 vol. %, from about 1 vol. % to about 50 vol. %, from about 1 vol. % to about 40 vol. %, from about 1 vol. % to about 30 vol. %, from about 1 vol. % to about 20 vol. %, from about 1 vol. % to about 10 vol. %, from about 10 vol. % to about 99 vol. %, from about 20 vol. % to about 99 vol. %, from about 30 vol. % to about 99 vol. %, from about 40 vol. % to about 99 vol. %, from about 50 vol. % to about 100 vol. %, from about 60 vol. % to about 100 vol. %, from about 70 vol. % to about 100 vol. %, from about 80 vol. % to about 100 vol. %, or from about 90 vol. % to about 100 vol. %, based on the total volume of the drilling fluid. In some embodiments, the amount of the farnesane in the drilling fluid is less than 30 vol. %, based on the total volume of the drilling fluid.

In some embodiments, the ratio of the farnesane to the farnesene is from about 99:1 to about 1:99, from about 90:1 to about 1:90, from about 80:1 to about 1:80, from about 70:1 to about 1:70, from about 60:1 to about 1:60, from about 50:1 to about 1:50, from about 40:1 to about 1:40, from about 30:1 to about 1:30, from about 20:1 to about 1:20, from about 10:1 to about 1:10, from about 5:1 to about 1:5, from about 4:1 to about 1:4, from about 3.5:1 to about 1:3.5, from about 3:1 to about 1:3, from about 2.5:1 to about 1:2.5, from about 2:1 to about 1:2, from about 1.5:1 to about 1:1.5. The ratio can be by mole, weight or volume. In certain embodiments, the vol. ratio of the farnesane to the farnesene is less than 3:7.

In certain embodiments, the drilling fluid disclosed herein is substantially free of a cyclic terpene, dimethyloctane or a combination thereof. The cyclic terpene can be a monocyclic terpene, a bicyclic terpene, a tricyclic terpene or a combination thereof. The cyclic terpene can be saturated and unsaturated. Some non-limiting examples of monocyclic terpene include d-limonene, pinene, dipentene, p-cymene, 1,3-p-menthadiene, 2,4-p-menthadiene, 1(7),8-p-menthadiene, 2,8-p-menthadiene, 3,8-p-menthadiene, 1('7),2-p-menthadiene, p-menthane and m-menthane. Some non-limiting examples of bicyclic terpene include pinene, 2-carene, 3-carene, 3(10)-carene, pinane, camphane, carane and thujane. Some non-limiting examples of tricyclic terpene include tricyclene and cyclofenchene.

The weighting agent in the drilling fluid disclosed herein can be any compound that can increase the density of the drilling fluid and thereby increase the hydrostatic weight of a column of the drilling fluid to control the pressures of the formations. Some non-limiting examples of suitable properties of the weighting agent include specific gravity, insolubility and chemical inertness. Table 1 below lists exemplary weighting agents and their properties.

TABLE 1
Solid Materials Used to Increase Density of Drilling Muds

| | CAS Registry | | Specific | Hardness, | | |
|---|---|---|---|---|---|---|
| Material | number | Formula | gravity | Mohs' | Characteristics | Advantages |
| barite | [13462-38-2] | BaSO₄ | 4.5^{a}, 4.2^{b} | 2.5-3.5 | white gray-red | readily |
| | | | | | | available; |
| | | | | | | low cost |
| hematite | [1817-60-8] | Fe₂O₃ | 4.9-5.3 | 5.5-6.5 | iron oxide, | low attrition |
| | | | | | impurities; | rate; API |
| | | | | | black to red | high |
| | | | | | depending on | density |
| | | | | | particle size | |
| magnetite | [1309-38-2] | Fe₂O₄ | 5.0-5.2 | 5.5-6.5 | iron ore, often | high density; |
| | | | | | Ti and Mg; | HCl |
| | | | | | black ore | soluble; |
| | | | | | | scavenges |
| | | | | | | H₂S |
| siderite | [14476-16-5] | FeCO₃ | 3.7-3.9 | 3.5-4 | spathic iron | acid soluble |
| | | | | | ore, various | |
| | | | | | colors | |
| dolomite | [18889-88-1] | CaCO₂—MgCO₃ | 2.8-2.9 | 3.5-4 | carbonate of | acid soluble |
| | | | | | Mg, Ca | |
| calcite | [13397-26-7] | CaCO₂ | 2.6-2.8 | 3 | limestone, | highly acid |
| | | | | | occurs in | soluble, |
| | | | | | sedimentary | range of |
| | | | | | rock | particle |
| | | | | | | sizes |
| sodium | [7847-14-5] | NaCl | 2.105 | 2 | cubic structure, | water soluble, |
| chloride | | | | | | used as |
| | | | | | | bridging |
| | | | | | | solids |

^{a}Value is for pure material.
^{b}Value for API grade.

In certain embodiments, the weighting agent is barite, hematite, magnetite, siderite, dolmite, calcite, sodium chloride, or a combination thereof. In some embodiments, the weighting agent is barite. In other embodiments, the weighting agent is hematite. In other embodiments, the barite or hematite meets the API specifications listed in Table 2 below.

TABLE 2
API Specifications for Barite and Hematite

| Assay | Barite^{a} | Hematite^{b} |
|---|---|---|
| specific gravity^{c} | 4.20 | 5.05 |
| wet-screen analysis, % residue^{d} | | |
| >75 μm | 3.0 | 1.5 |
| >45 μm | | 15 |
| particles, <6 μm, %^{d} | 30 | 15 |
| soluble alkaline-earth metals | 250 | 100 |
| as calcium, mg/kg^{d} | | |

Some other weighting agents and useful additives for drilling fluids are described in Caenn et al., “Composition and Properties of Drilling and Completion Fluids,” Elsevier Inc., Sixth Ed. (2011), which is incorporated herein by reference in its entirety. In certain embodiments, an amount of the weighting agent is added to adjust the density of the drilling fluid to greater than about 1.1 g/cc, greater than about 1.15 g/cc, greater than about 1.20 g/cc, greater than about 1.25 g/cc, greater than about 1.30 g/cc, or greater than about 1.35 g/cc.

The viscosifier in the oil-based drilling fluid disclosed herein can be any compound that can make the oil-based drilling fluid thick enough to carry cuttings to the surface. In some embodiments, the viscosifier is any clay mineral that is capable of gelling various organic liquids such as hydrocarbons. In some embodiments, the viscosifier is an organophillic clay. Any organophillic clay that can swell in and gel various organic liquids can be used herein. The organophilic clay can be prepared by any methods known to skilled artisans. In some embodiments, the organophilic clay is prepared by an ion exchange reaction between long-chain organic cations (e.g., aliphatic quaternary amine cations) and minerals (e.g., bentonite, hectorite, attapulgite, and phyllosilicates such as montmorillonite). Some suitable methods of making organophilic clays are described in J. W. Jordan, “Organophilic Clay-Base Thickeners,” Clays and Clay Minerals, v. 10, no. 1; p. 299-308 (1961), which is incorporated herein by reference. In some embodiments, the organophilic clay is prepared from an ion exchange reaction between bentonite, hectorite, or attapulgite and an aliphatic quaternary amine salt. In some embodiments, the aliphatic amine salt comprises a linear aliphatic moiety having from about 12 to about 20 carbons. In other embodiments, the aliphatic amine salt comprises a linear aliphatic moiety having at least 12 carbon atoms, at least 14 carbon atoms, at least 16 carbon atoms, at least 18 carbon atoms, or at least 20 carbon atoms. These organophilic clays swell and forms gels in hydrocarbon fluids. The amount of organophilic clays can be from about 1 to about 50 kg/m³, from about 1 to about 40 kg/m³, or from about 2 to about 30 kg/m³. In some embodiments, the organophilic clay is sufficient to suspend the solids in the continuous phase without the addition of an emulsifier or a surfactant.

The drilling fluid disclosed herein can further comprise one or more additives to control the properties of the drilling fluid. Some non-limiting examples of suitable additives include emulsifiers, surfactants, fluid loss reducers, lubricants, deflocculants, defoamers, and combinations thereof. In some embodiments, the total amount of the additives is from about 0.1 vol. % to about 40 vol. %, from about 0.1 vol. % to about 30 vol. %, from about 0.1 vol. % to about 20 vol. %, from about 0.1 vol. % to abou^{t} 15 vol. %, from about 0.1 vol. % to about 10 vol. %, or from about 0.1 vol. % to about 5 vol. %, based on the total volume of the drilling fluid. In certain embodiments, the amount of each additive is from about 0.1 vol. % to about 20 vol. %, from about 0.1 vol. % to about 15 vol. %, from about 0.1 vol. % to about 10 vol. %, or from about 0.1 vol. % to about 5 vol. %, from about 0.1 vol. % to about 2.5 vol. %, or from about 0.1 vol. % to about 1 vol. %, based on the total volume of the drilling fluid.

In some embodiments, the drilling fluid disclosed herein further comprises an emulsifier. Any compound that can maintain the emulsion of water in oil may be used. These materials include metal salts (e.g., calcium and magnesium salts) of fatty acids and polyamines and amides and their mixtures. In some embodiments, lime is added along with a fatty acid to form a soap emulsifier. In some embodiments, the emulsifier can be any surfactant disclosed herein.

In some embodiments, the drilling fluid disclosed herein further comprises a surfactant. Any surfactant that can lower the surface tension of a liquid, the interfacial tension between two liquids, or that between a liquid and a solid can be used herein. In some embodiments, the surfactant can limit tar accretion on metal surfaces. The surfactants disclosed herein can be used as detergents, wetting agents, emulsifiers, foaming agents and/or dispersants for the drilling fluid disclosed herein. The surfactant can be a cationic surfactant, an anionic surfactant, a non-ionic surfactant or a combination thereof.

Some non-limiting examples of suitable anionic surfactants include alkyl sulfates (e.g., ammonium lauryl sulfate and sodium lauryl sulfate); alkyl ether sulfates (e.g., sodium laureth sulfate and sodium myreth sulfate); docusates (e.g., dioctyl sodium sulfosuccinate); sulfonate fluorosurfactants (e.g., perfluorooctanesulfonate (PFOS), perfluorobutanesulfonate); alkyl benzene sulfonates; phosphates (e.g., alkyl aryl ether phosphate and alkyl ether phosphate); and carboxylates (e.g., alkyl carboxylates, sodium lauroyl sarcosinate, carboxylate fluorosurfactants).

Some non-limiting examples of suitable cationic surfactants include pH-dependent primary, secondary, or tertiary amines (e.g., Octenidine dihydrochloride); and quaternary ammonium salt (e.g., alkyltrimethylammonium salts, cetylpyridinium chloride, benzalkonium chloride, benzethonium chloride, 5-bromo-5-nitro-1,3-dioxane, dimethyldioctadecylammonium chloride, dioctadecyldimethylammonium bromide).

Some non-limiting examples of suitable non-ionic surfactants include fatty alcohols (e.g., cetyl alcohol, stearyl alcohol, cetostearyl alcohol, and oleyl alcohol); polyoxyethylene glycol alkyl ethers (e.g., octaethylene glycol monododecyl ether and pentaethylene glycol monododecyl ether); polyoxypropylene glycol alkyl ethers; glucoside alkyl ethers (e.g., decyl glucoside, lauryl glucoside, octyl glucoside); polyoxyethylene glycol octylphenol ethers (e.g., TRITON™ X-100); polyoxyethylene glycol alkylphenol ethers (e.g., nonoxynol-9); glycerol alkyl esters (e.g., glyceryl laurate); polyoxyethylene glycol sorbitan alkyl esters (e.g., polysorbate); sorbitan alkyl esters (e.g., SPANS™); cocamide MEA; cocamide DEA; dodecyldimethylamine oxide; block copolymers of polyethylene glycol and polypropylene glycol (e.g., Poloxamers); and polyethoxylated tallow amine.

In some embodiments, the non-ionic surfactants include alcohol ethoxylates (e.g., ethoxylated alcohols and ethoxylated propoxylated alcohols). The alcohol ethoxylates may be branched or have one or more alkyl end groups. In some embodiments, the non-ionic surfactants include alkyl polyethylene glycol ethers based on C₁₀-guerbet alcohol and ethylene oxide; chlorine capped ethoxylated C₁₀₋₁₄-ISO alcohols (e.g., ANTAROX™ BL-330 from Rhodia); chlorine capped ethoxylated C₉₋₁₁-ISO, C₁₀ rich alcohols (e.g., ANTAROX™ LF-330 from Rhodia); alcohol ethoxylates having one or more alkyl end groups (e.g., DEHYPON™ G 2084 from Cognis); and branched secondary alcohol ethoxylates (e.g., TERGITOL™ TMN Series from Dow Chemical Company).

Filtration control in the drilling fluids herein is achieved by the properties of the emulsified aqueous phase and by the addition of a fluid loss reducer. Some non-limiting examples of suitable fluid loss reducers include bentonite, powdered lignite, asphalt (e.g., powdered asphalt and sulfonated asphalt), gilsonite, sodium polyacrylates, polyanionic cellulose, starches, carboxy methyl cellulose and combinations thereof. In some embodiments, aqueous dispersions of styrene-butadiene copolymers can also be used. In certain embodiments, the amount of the fluid loss reducers is from about 1 kg/m³ to about 40 kg/m³, or from about 10 kg/m³ to about 25 kg/m³. In some embodiments, an amount of the fluid loss reducer is added to adjust the water loss of the drilling fluid to less than about 15 cc, less than about 12 cc, less than about 10 cc, less than about 8 cc, less than about 6 cc, or less than about 4 cc, as measured according to ASTM D5891, which is incorporated herein by reference.

In some embodiments, the drilling fluid disclosed herein further comprises a wetting agent to keep the solids present in the non-aqueous phase of the oil-based drilling fluids wet to prevent coagulation and settling and to reduce mud instability. Some suitable wetting agents comprise amines or quaternary ammonium salts having hydrocarbon chains of 10 or more carbon atoms. Another example of suitable wetting agent is lecithin.

In some embodiments, the drilling fluid disclosed herein further comprises a lubricant. Any lubricant that can provide a lubricating action to assist drilling and running liners into long horizontal sections of a wellbore can be used herein. Some non-limiting examples of suitable lubricants include plant product oils and derivatives thereof including fatty acid methyl esters, vegetable oil or derivatives thereof, soybean oil or derivatives such as soya methyl ester, canola methyl ester, and canola oil or its derivatives.

In some embodiments, the drilling fluid disclosed herein further comprises a deflocculant. Any deflocculant that can prevent a colloid from coming out of suspension or to thin suspensions or slurries can be used herein. Deflocculants can be low-molecular-weight anionic polymers that neutralize positive charges on suspended particles in clays and aryl-alkyl derivative of sulfonic acid. Some non-limiting examples of suitable deflocculants include polyphosphates, lignosulfonates, quebracho tannins, anionic polyelectrolytes (e.g., acrylates, polyphosphates, lignosulfonates and tannic acid derivates), various water-soluble synthetic polymers, and combinations thereof.

In some embodiments, the drilling fluid disclosed herein further comprises a defoamer. Any defoamer that can reduce or hinder the formation of foam in drilling fluid can be used herein. Some non-limiting examples of suitable defoamers include silicone defoamers, fatty alcohol ethoxylate defoamers, stearate defoamers and combinations thereof.

In some embodiments, the farnesene is α-farnesene having a structure:

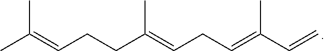

In some embodiments, the farnesene is β-farnesene having a structure:

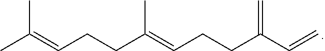

The farnesenes can be derived from any source or prepared by any method known to a skilled artisan. In some embodiments, the farnesene is derived from a chemical source (e.g., petroleum or coal) or obtained by a chemical synthetic method. In other embodiments, the farnesene is prepared by fractional distillation of petroleum or coal tar. In further embodiments, the farnesene is prepared by any known chemical synthetic method. One non-limiting example of suitable chemical synthetic method includes dehydrating nerolidol with phosphoryl chloride in pyridine as described in the article by Anet E. F. L. J., “Synthesis of (E,Z)-α-,(ZZ)-α-, and (Z)-β-farnesene,” Aust. J. Chem., 23(10), 2101-2108 (1970), which is incorporated herein by reference.

In some embodiments, the farnesenes can be obtained or derived from naturally occurring terpenes that can be produced by a wide variety of plants, such as Copaifera langsdorfii, conifers, and spurges; insects, such as swallowtail butterflies, leaf beetles, termites, and pine sawflies; and marine organisms, such as algae, sponges, corals, mollusks, and fish.

α-Farnesene can be found in various biological sources including, but not limited to, the Dufour's gland in ants and in the coating of apple and pear peels. Biochemically, α-farnesene is made from FPP by α-farnesene synthase. β-Farnesene can be found in various biological sources including, but not limited to, aphids and essential oils such as peppermint oil. In some plants such as wild potato, β-farnesene is synthesized as a natural insect repellent. Biochemically, β-farnesene is made from FPP by β-farnesene synthase. Some biologically methods of making α-farnesene and β-farnesene are disclosed in U.S. Pat. No. 7,399,323 and U.S. Pat. No. 7,655,739, both of which are incorporated herein by reference.

In some embodiments, the farnesane, whose structure is

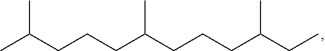

can be prepared by hydrogenating a farnesene such as α-farnesene or β-farnesene in the presence of a hydrogenation catalyst.

In some embodiments, the hydrogenation catalyst is Pd, Pd/C, Pt, PtO₂, Ru(PPh₃)₂Cl₂, Raney nickel, or combinations thereof. In one embodiment, the hydrogenation catalyst is a Pd catalyst. In another embodiment, the hydrogenation catalyst is 5% Pd/C. In a further embodiment, the hydrogenation catalyst is 10% Pd/C in a high pressure reaction vessel and the reaction is allowed to proceed until completion. Generally, after completion, the reaction mixture can be washed, concentrated, and dried to yield the corresponding hydrogenated product. Alternatively, any reducing agent that can reduce a C═C bond to a C—C bond can also be used. For example, the farnesene can be hydrogenated by treatment with hydrazine in the presence of a catalyst, such as 5-ethyl-3-methyllumiflavinium perchlorate, under O₂ atmosphere to give the corresponding hydrogenated products. The reduction reaction with hydrazine is disclosed in Imada et al., J. Am. Chem. Soc., 127, 14544-14545 (2005), which is incorporated herein by reference.

The hydrogenation of the farnesene can be carried out in the presence of an asymmetric hydrogenation catalyst such as rhodium-chiral diphosphine complex to form stereospecific hydrogenated products substantially free of other stereoisomers. A non-limiting example of the asymmetric hydrogenation catalyst includes the rhodium-DIPAMP catalyst. The rhodium-DIPAMP catalyst and other asymmetric hydrogenation catalysts are disclosed in Vineyard et al., J. Am. Chem. Soc. 1977, 99, (18), 5946; Ryoji Noyori, “Asymmetric Catalysis In Organic Synthesis,” John Wiley & Sons Inc., New York, Chapter 2, pp. 16-94 (1994); and Blaser et al., “Asymmetric Catalysis on Industrial Scale: Challenges, Approaches and Solutions,” Wiley-VCH, Weinheim, pp. 23-52 (2004), all of which are incorporated herein by reference in their entirety.

α-Farnesene and β-farnesene can be hydrogenated in the presence of an asymmetric hydrogenation catalyst to form one or more of the four possible stereoisomers of farnesane, i.e., compounds (III-a), (III-b), (III-c), and (III-d), as shown below.

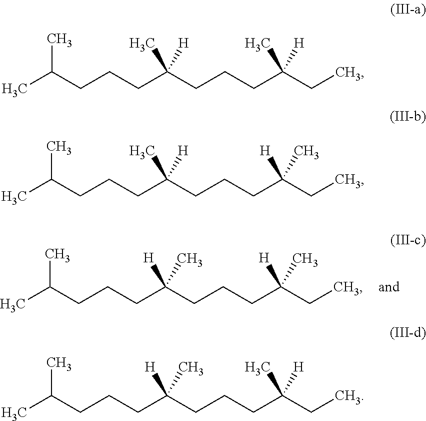

The drilling fluid disclosed herein can be produced in a cost-effective and environmentally friendly manner. In certain embodiments, the present invention encompasses a drilling fluid comprising a bioengineered α-farnesene, β-farnesene, farnesane or a combination thereof. The α-farnesene, β-farnesene and farnesane can thus provide a renewable source and environmentally friendly drilling fluid. Further, these isoprenoid compounds can decrease dependence on non-renewable sources of drilling fluids.

### EXAMPLES

### Example 1

Farnesane (20 gallons) is added to a 55 gallon drum equipped with a mechanical stirrer. MF-OILVIS (an organophilic clay commercially available from Marquis Alliance Energy Group USA, Denver, Colo.) is added in an amount from about 2.85 kg/m³ to about 14.25 kg/m³ to the drum. The drilling fluid is adjusted to a density about 13 pounds/gallon with barite. The mixture is mixed for 18 hours to form a drilling fluid.

### Example 2

Farnesene (20 gallons) is added to a 55 gallon drum equipped with a mechanical stirrer. MF-OILVIS (an organophilic clay commercially available from Marquis Alliance Energy Group USA, Denver, Colo.) is added in an amount from about 2.85 kg/m³ to about 14.25 kg/m³ to the drum. The drilling fluid is adjusted to a density about 13 pounds/gallon with barite. The mixture is mixed for 18 hours to form a drilling fluid.

All publications, patents and patent applications cited in this specification are incorporated herein by reference as if each such publication, patent or patent application were specifically and individually indicated to be incorporated herein by reference.

What is claimed is:

1. A drilling fluid comprising a weighting agent, a viscosifier and a farnesane, wherein the drilling fluid is free of a cyclic terpene and dimethyloctane.

2. The drilling fluid of claim 1, wherein the farnesane is in an amount from about 1 vol. % to about 95 vol. %, based on the total volume of the drilling fluid.

3. A drilling fluid comprising a weighting agent, a viscosifier and a farnesene, wherein the drilling fluid is free of a cyclic terpene and dimethyloctane.

4. The drilling fluid of claim 3, wherein the farnesene is in an amount from about 1 vol. % to about 95 vol. %, based on the total volume of the drilling fluid.

5. The drilling fluid of any one of claims 1-4, wherein the weighting agent is barite.

6. The drilling fluid of any one of claims 1-5, wherein the viscosifler is an organophillic clay.

7. The drilling fluid of claim 6 further comprising an asphalt.

8. A drilling fluid comprising:
(a) a continuous phase comprising a farnesane in an amount from about 1 vol. % to about 100 vol. %, based on the total volume of the continuous phase, wherein the continuous phase is free of a cyclic terpene and dimethyloctane; and
(b) a discontinuous phase comprising water or an aqueous solution, an emulsifier, a weighting agent and a viscosifier.

9. The drilling fluid of claim 8, wherein the amount of the farnesane is from about 1 vol. % to about 50 vol. %, based on the total volume of the continuous phase.

10. The drilling fluid of claim 8, wherein the amount of the farnesane is from about 50 vol. % to about 100 vol. %, based on the total volume of the continuous phase.

11. The drilling fluid of claim 1 or 8, wherein the drilling fluid further comprises a farnesene.

12. The drilling fluid of claim 11, wherein the total amount of the farnesane and the farnesene is from about 1 vol. % to about 95 vol. %, or from about 1 vol. % to about 100 vol. %, based on the total volume of the continuous phase.

13. The drilling fluid of claim 11, wherein the total amount of the farnesane and the farnesene is from about 1 vol. % to about 50 vol. %, based on the total volume of the continuous phase.

14. The drilling fluid of claim 11, wherein the total amount of the farnesane and the farnesene is from about 50 vol. % to about 100 vol. %, based on the total volume of the continuous phase.

15. The drilling fluid of any one of claims 11-14, wherein the mole ratio of the farnesane to the farnesene is from about 10:1 to about 1:10.

16. A drilling fluid comprising:
(a) a continuous phase comprising a farnesene in an amount from about 1 vol. % to about 100 vol. %, based on the total volume of the continuous phase, wherein the continuous phase is free of a cyclic terpene and dimethyloctane; and
(b) a discontinuous phase comprising water or an aqueous solution, an emulsifier, a weighting agent and a viscosifier.

17. The drilling fluid of claim 16, wherein the amount of the farnesene is from about 50 vol. % to about 100 vol. %, based on the total volume of the continuous phase.

18. The drilling fluid of claim 16, wherein the amount of the farnesene is from about 1 vol. % to about 50 vol. %, based on the total volume of the continuous phase.

19. The drilling fluid of any one of claims 8-18, wherein the continuous phase further comprises a diesel oil, a mineral oil, a vegetable oil, a biodiesel oil, a liquid ester, a liquid poly-α-olefin, a liquid mono-ether, a liquid di-ether, a linear alkylbenzene or a combination thereof.

20. The drilling fluid of any one of claims 1-19, wherein the continuous phase is substantially free of a diesel oil, a mineral oil, a vegetable oil, a biodiesel oil, a liquid ester, a liquid poly-α-olefin, a liquid mono-ether, a liquid di-ether, a linear alkylbenzene or a combination thereof.

21. A drilling fluid comprising famesane and an organophilic clay.

22. A drilling fluid comprising farnesene and an organophilic clay.

23. The drilling fluid of claim 21 or 22 further comprising an asphalt.

24. The drilling fluid of any one of claims 21-23 further comprising a weighting agent.

25. The drilling fluid of any one of claims 21-24 further comprising an emulsifier and water or an aqueous solution.

26. The drilling fluid of any one of claims 8-23 and 25, wherein the aqueous solution is sea water, a brine, or a combination thereof.

27. The drilling fluid of claim 26, wherein the brine comprises sodium chloride, calcium chloride, or a combination thereof.
